(19) United States
(12) Patent Application Publication
(10) Pub. No.: US 2022/0405245 A1
(43) Pub. Date: Dec. 22, 2022

(54) USER-BASED ACCESS TO CONTENT OF FILES

(71) Applicant: Citrix Systems, Inc., Fort Lauderdale, FL (US)

(72) Inventors: Ke Xu, Nanjing (CN); Zongpeng Qiao, Nanjing (CN); Jie Zhuang, Nanjing (CN); Xiao Zhang, Nanjing (CN)

(21) Appl. No.: 17/361,415

(22) Filed: Jun. 29, 2021

Related U.S. Application Data
(63) Continuation of application No. PCT/CN2021/100539, filed on Jun. 17, 2021.

(51) Int. Cl. G06F 16/176; G06F 16/182; G06F 16/17; G06F 21/62

(52) U.S. Cl. CPC G06F 16/176; G06F 16/182; G06F 16/1734; G06F 21/6218

(57) ABSTRACT

A computing system may receive an input indicative of at least one portion of a first file is to be made accessible to a first user, and may generate a second file including the at least one portion of the first file and excluding other portions of the first file. Based on determining that the first file is to be shared with the first user, the computing system may send, to a second client device operated by the first user, the second file so as to limit access, by the first user, to contents of the first file.

### CROSS-REFERENCE TO RELATED APPLICATIONS

This application is a continuation of and claims the benefit under 35 U.S.C. § 120 and 35 U.S.C. § 365(c) to International Application PCT/CN2021/100539, entitled USER-BASED ACCESS TO CONTENT OF FILES, with an international filing date of Jun. 17, 2021, the entire contents of which are incorporated herein by reference for all purposes.

### BACKGROUND

Various file sharing systems have been developed that allow users to share files or other data. ShareFile®, offered by Citrix Systems, Inc., of Fort Lauderdale, Fla., is one example of such a file sharing system.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves receiving, by a computing system and from a first client device operated by an owner of a first file, an input indicative of at least one portion of the first file is to be made accessible to a first user; determining that the first file is to be shared with the first user; generating, by the computing system based on the input from the first client device and the first file, a second file including the at least one portion of the first file and excluding other portions of the first file; and based on determining that the first file is to be shared with the first user, sending, by the computing system to a second client device operated by the first user, the second file so as to limit access, by the first user, to content of the first file.

In some of the disclosed embodiments, a method involves receiving, by a computing system and from a first client device operated by a first user, a request for a copy of a first file; determining, by the computing system, first data indicative of at least one portion of the first file is to be made accessible to the first user, the first data being indicated by an owner of the first file; generating, by the computing system and based on the first data, a second file including the at least one portion of the first file and excluding other portions of the first file; and in response to the request for the copy of the first file, sending, by the computing system to the first client device, the second file so as to limit access, by the first user, to content of the first file.

In some disclosed embodiments, a computing system comprise at least one processor, and at least one computer-readable medium encoded with instruction which, when executed by the at least one processor, cause the computing system to receive, from a first client device operated by an owner of a first file, an input indicative of at least one portion of the first file is to be made accessible to a first user; determine that the first file is to be shared with the first user; generate, based on the input from the first client device and the first file, a second file including the at least one portion of the first file and excluding other portions of the first file; and based on determining that the first file is to be shared with the first user, send, to a second client device operated by the first user, the second file so as to limit access, by the first user, to content of the first file.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is a diagram of how a system may limit access to content of a file, in accordance with the present disclosure;

FIG. 1B shows an example user interface screen for a user to provide content access information for a file;

FIG. 1C shows an example user interface screen illustrating inputs indicative of different portions of a file to be made accessible to different users;

FIG. 1D shows an example user interface screen displaying contents of a file generated for a first user based on the inputs illustrated in FIG. 1C;

FIG. 1E shows an example user interface screen displaying contents of another file generated for a second user based on the inputs illustrated in FIG. 1C;

FIG. 1F shows an example user interface screen illustrating inputs indicative of different portions of a file to be made accessible to different users;

FIG. 1G shows an example user interface screen displaying contents of a file generated for a first user based on the inputs illustrated in FIG. 1F;

FIG. 1H shows an example user interface screen displaying contents of another file generated for a second user based on the inputs illustrated in FIG. 1F;

FIG. 2 is a diagram of a network environment in which some embodiments of the present disclosure may be deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like one shown in FIG. 2 may be configured to allow clients access to an example embodiment of a file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6 is a diagram illustrating an example content control system, in accordance with some embodiments;

FIG. 7 shows a first example routine that may be performed by the content control system shown in FIG. 6 in accordance with some embodiments;

FIG. 8 shows a second example routine that may be performed by a client device in accordance with some embodiments; and

FIG. 9 shows a third example routine that may be performed by the content control system shown in FIG. 6 in accordance with some embodiments.

### DETAILED DESCRIPTION

Users may create numerous files to perform various tasks for their work or for handling personal/non-work items. Often users share the created files with other users for collaboration purposes. Sometimes, the creator of the file may want to prevent some other users from accessing certain contents of the created file, while still sharing the file with these users. For example, a company may hire some temporary employees to work on a project involving one or more files created by a manager (referred to herein as “an owner of the file” or “file owner”), and the files may contain certain sensitive information that the company does not want to share with the temporary employees. To allow the temporary employees access to the content of files while preventing access to the sensitive information, traditionally, the owner of the file may manually create a file containing the non-sensitive information, and share this file with the temporary employees.

The inventors of have recognized and appreciated that the foregoing manner of sharing files with non-sensitive information is inefficient and poses significant security risks that may involve loss of sensitive or confidential information, especially when a file is to be shared with multiple users, and when different users are to have access to different contents of the file. Offered are systems and techniques for enabling an owner of a file to select which portions of a file are to be made accessible to which individual users. The systems and techniques enable the owner of the file to share the file with multiple users, and the system automatically generates separate files including the appropriate portions of the file to be shared with the appropriate users. In some embodiments, the owner of the file may select portions of the file to be made accessible to a group of users, rather than an individual user. The systems and techniques described herein provide an efficient and secure way of controlling/limiting access, at a user level, to contents of a file shared with multiple users, thus enhancing privacy protection for shared files and improving the user experience in sharing files.

For purposes of reading the description of the various embodiments below, the following descriptions of the sections of the specification and their respective contents may be helpful:

Section A provides an introduction to example embodiments of a system for providing user-based access to content of files;

Section B describes a network environment which may be useful for practicing embodiments described herein;

Section C describes a computing system which may be useful for practicing embodiments described herein.

Section D describes embodiments of systems and methods for delivering shared resources using a cloud computing environment;

Section E describes example embodiments of systems for providing file sharing over networks;

Section F provides a more detailed description of example embodiments of the system for providing user-based access to content of files introduced in Section A; and

Section G describes example implementations of methods, systems/devices, and computer-readable media in accordance with the present disclosure.

### A. Introduction to Illustrative Embodiments of a System for Providing User-Based Access to Content of Files

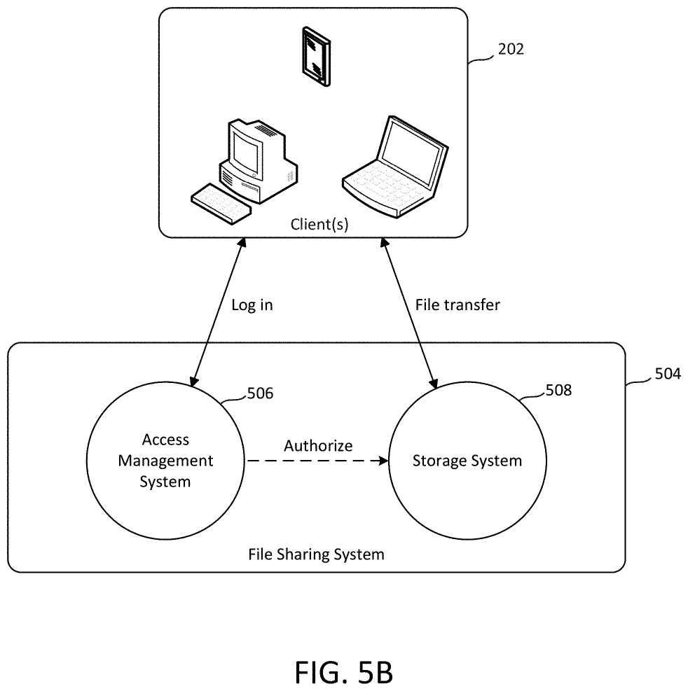

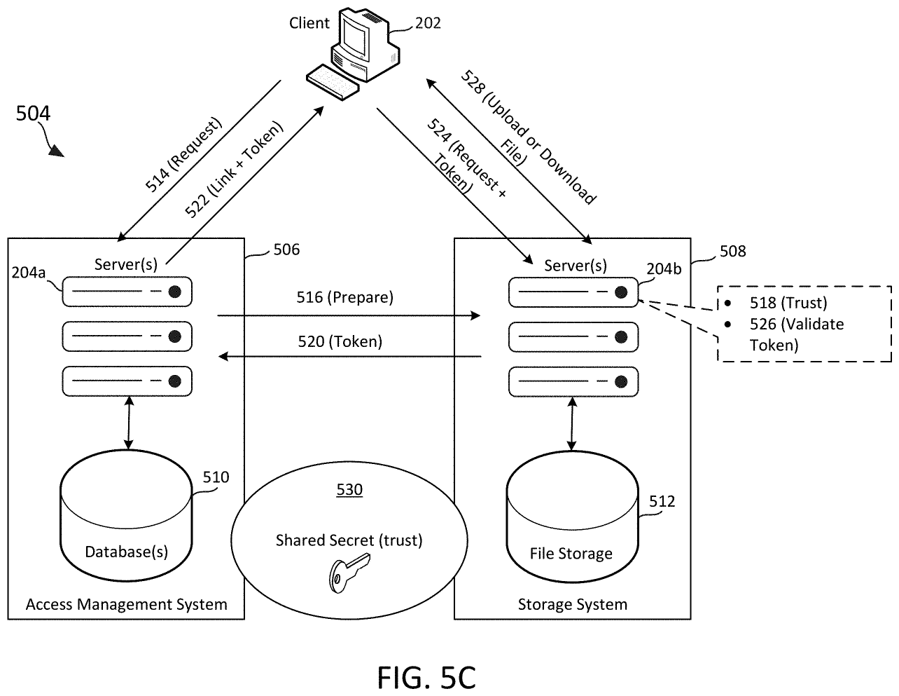

Various file sharing systems have been developed that allow users to share files with other users over a network. An example of such a file sharing system 504 is described below (in Section F) in connection with FIGS. 5A-C. As explained in Section F, in some implementations, one client device 202 may upload a file 502 (shown in FIG. 5A) to a central repository of the file sharing system 504, such as a storage medium(s) 512 shown in FIGS. 5A and C, and another client device 202 may then download a copy of that file 502 from the same repository. As Section F also describes, in some implementations, an access management system 506 may regulate the circumstances in which files 502 may be uploaded and/or downloaded to/from a storage system 508 (including the storage medium(s) 512) by various client devices 202.

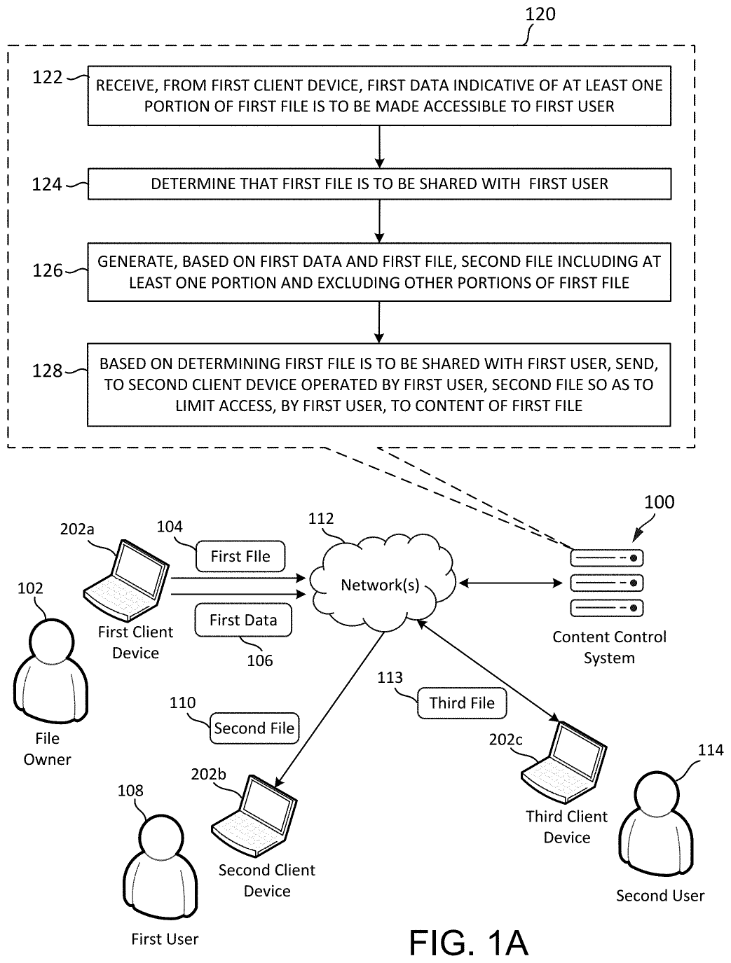

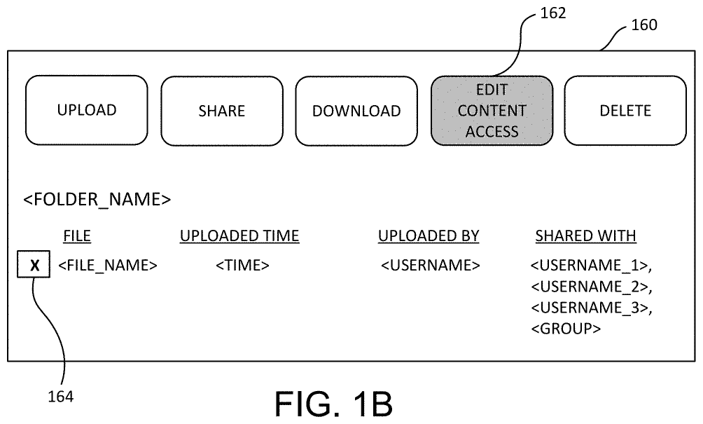

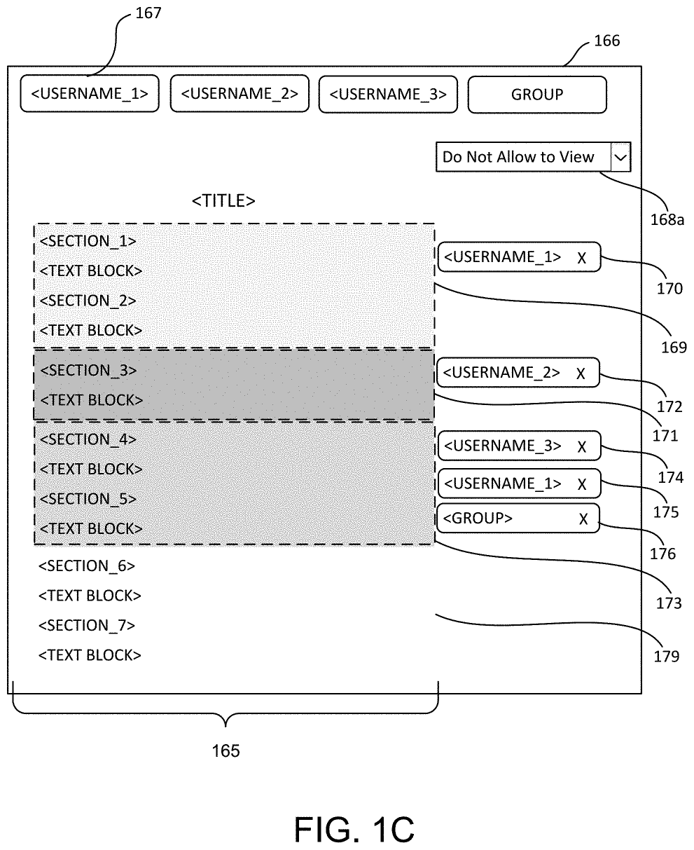

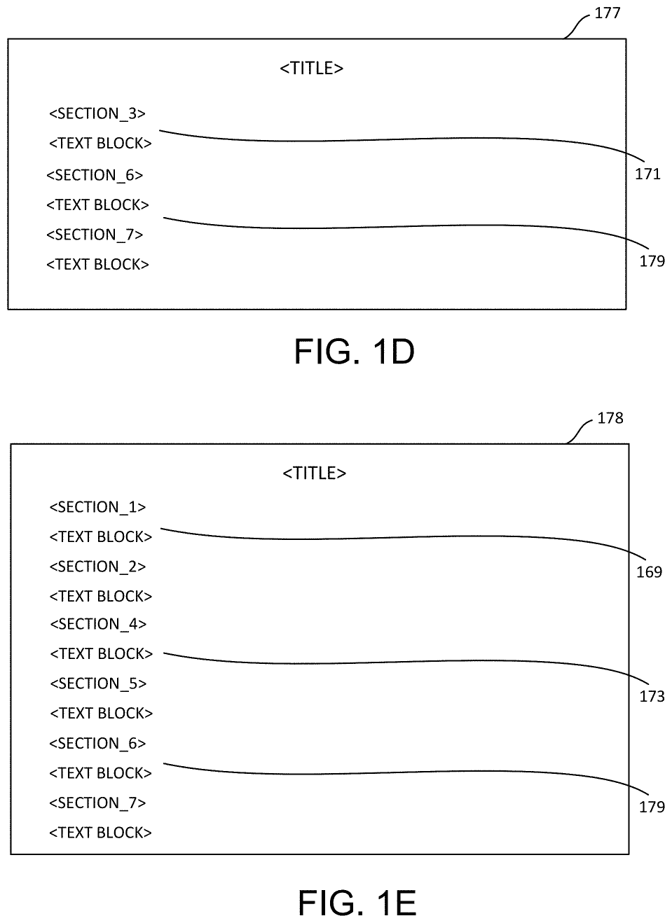

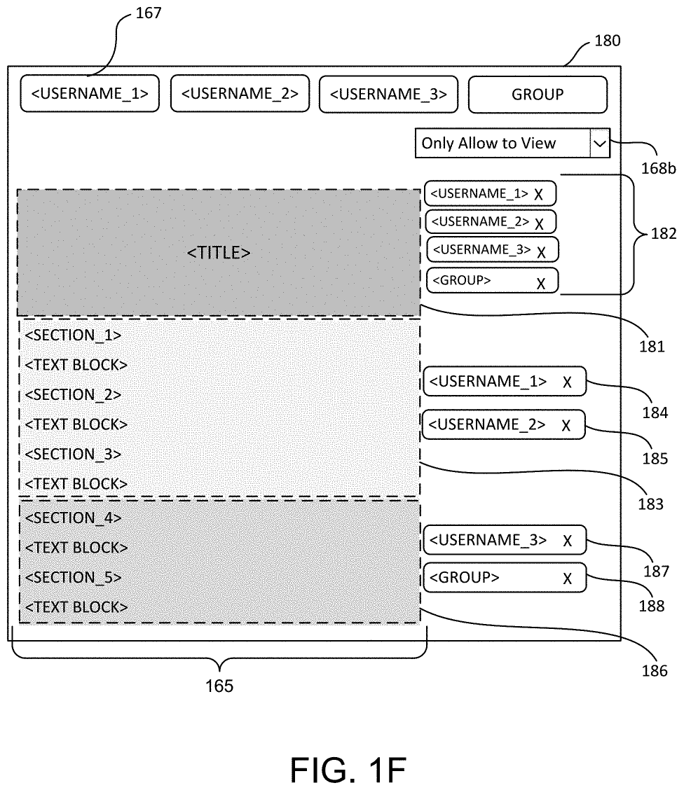

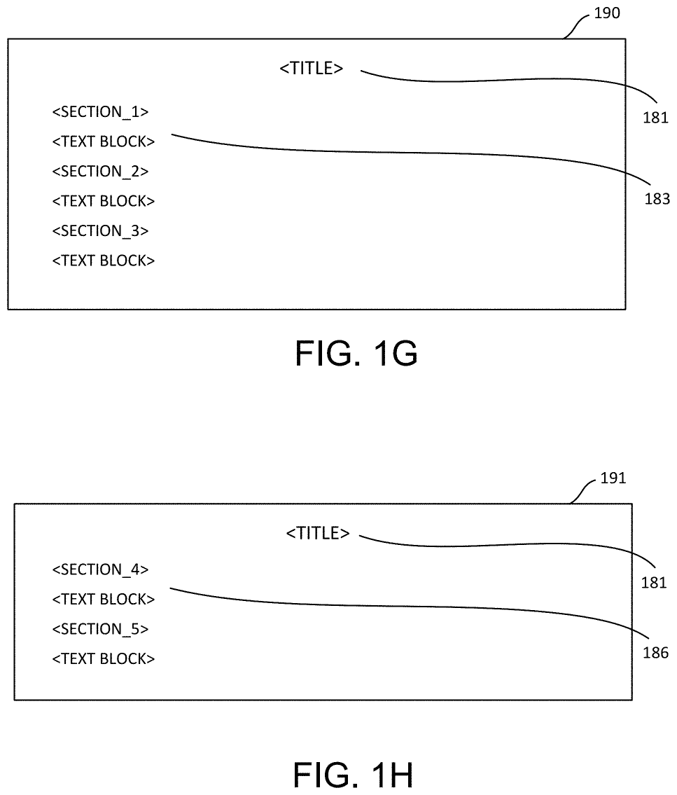

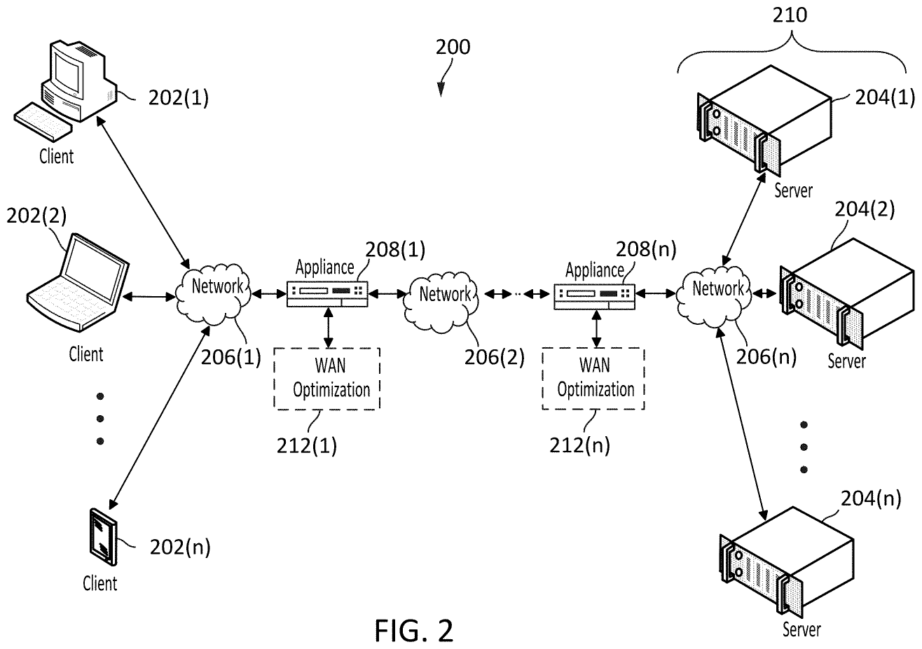

At a high level, a user of the file sharing system 504 (e.g., a file owner 102 shown in FIG. 1A) may want to share a file (e.g., a first file 104 shown in FIG. 1A) with multiples users (e.g., a first user 108 and a second user 114 shown in FIG. 1A), but may want to limit which portions of the file each of the user can access/view. The file owner 102 may provide an input, via a client device 202 (e.g., a first client device 202a shown in FIG. 1A) selecting one or more portions of the first file 104 that are to be made accessible to the first user 108. Using the input, the content control system 100 may generate another file (e.g., by copying an existing file and modifying it; by copying portions from an existing file into a new file; etc.) to include the selected one or more portions of the first file 104 and excludes the non-selected portions of the first file 104. To make the first file 104 available to the first user 108 (e.g., in response to the file owner 102 sharing the first file 104 with the first user 108 and/or in response to the first user 108 requesting a copy of the first file 104), the content control system 100 may send the generated file (e.g., a second file 110) to a client device 202 (e.g., a second client device 202b) operated by the first user 108. Similarly, the file owner 102 may provide additional inputs selecting one or more portions of the first file 104 that are to be made accessible to another user (e.g., a second user 114 shown in FIG. 1A), and to make the first file 104 available to the second user 114, the content control system 100 may generate and send another file (e.g., a third file 113) to a client device 202 (e.g., a third client device 202c shown in FIG. 1A) operated by the second user 114, where the third file 113 includes the selected portions, for the second user, of the first file 104 and excludes the non-selected portions of the first file 104.

FIG. 1A thus illustrates how the content control system 100 may limit access by a user of contents of a file, in accordance with some embodiments of the present disclosure. In some embodiments, the content control system 100 may, for example, be part of/included in the file sharing system 504. In some embodiments, the file sharing system 504 may be in communication with the content control system 100. In some embodiments, the content control system 100 may include one or more servers 204 (examples of which are describe below in relation to FIG. 2). As shown in FIG. 1A, one or more client devices 202, operated by one or more users, may be in communication with the content control system 100 using one or more networks 112. An example routine 120 that may be performed by the content control system 100 is illustrated in FIG. 1A.

In some implementations, the file sharing system 504 may receive the first file 104, from the first client device 202a operated by the file owner 102, for sharing with one or more users. The client device 202a may, for example, send the first file 104 to the file sharing system 504 for upload and storage at the file sharing system 504. In some implementations, a file sharing application may be installed on the first client device 202a, and the file owner 102 may use the file sharing application to upload the first file 104 to the file sharing system 504. In some implementations, the file owner 102 may instead use a browser-based file sharing application to upload the first file 104 to the file sharing system 504. The file management application 513 described in Section E (in connection with FIG. 5A) is an example of a file sharing application that may be used for this purpose. As used herein, the file owner 102 may be a creator of the first file 104, an owner of the first file 104, a custodian of the first file 104, a sender user that sends/shares the first file 104 with recipient user(s), or may otherwise be a user that controls access to the first file 104.

In some implementations, the first file 104 may be provided to or made accessible to the content control system 100 by the file sharing system 504. The file owner 102 may provide an input at the first client device 202a indicating that the file owner 102 wants to control access to the first file 104 for one or more users that the first file 104 is to be shared with. Such input may be provided by the file owner 102 via the file sharing application. FIG. 1B illustrates an example user interface screen 160, including a button 162 labeled “edit content access”. The file owner 102 may select (or click) the button 162 to indicate that the file owner 102 wants to control access to contents of the first file 104. As shown in FIG. 1B using a checkbox 164 or the like, the file owner 102 may select a file for which the content access is to be limited/set. The user interface screen 160 may also include a name of the user that uploaded the file (e.g., the file owner 102), and a time that the file was uploaded. The user interface screen 160 may further include recipient names with whom the file is shared.

In response to receiving such input, the file sharing system 504 may activate, invoke, call or otherwise communicate with the content control system 100. In response to the input from the first client device 202a indicating that the file owner 102 wants to control access to the first file 104, the content control system 100, in some implementations, may cause the first client device 202a to display contents of the first file 104 to enable the file owner 102 to select which portions are to be made accessible to which users. FIG. 1C illustrates an example user interface screen 166 that may be displayed at the first client device 202a to enable the file owner 102 to select portions of the first file 104. As shown, the user interface screen 166 may include a list of recipient names with whom the file is shared. In some implementations, the recipient names may be provided as selectable interface elements (e.g., a button 167). The contents 165 of the first file 104 may be displayed in a portion of the user interface screen 166.

Referring to FIG. 1A, at a step 122 of the routine 120, the content control system 100 may receive, from the first client device 202a, an input indicative of at least one portion of the first file 104 is to be made accessible to the first user 108. In some implementations, the file owner 102 may select at least one portion of the contents of the first file 104 displayed at the first client device 202a. The file owner 102 may additionally provide an indication that the selected at least one portion is to be made accessible to the first user 108. The first client device 202a may send, to the content control system 100, first data 106 identifying the selected at least one portion of the first file 104 and the indication of the first user 108. In some implementations, the first data 106 may include data indicating/describing the selected at least one portion of the first file 104. Such data indicating/describing the selected at least one portion may be a page number(s) of the first file 104 (e.g., pages 1, 3 and 5), line numbers of the first file 104 (e.g., line numbers 6 to 12), section(s) of the first file 104 (e.g., section A, section II, etc.), paragraph number(s) of the first file 104 (e.g., first and second paragraphs), slide number(s) of the first file 104 (e.g., first and last slide), or other type of description.

In some implementations, the file owner 102 may indicate that a portion of the first file 104 is to be made accessible to a group of users. The group of users may be identified by a group name, which may be created by the file owner 102 to include multiple users for the file sharing system 504. In other implementations, the group of users may be a pre-identified group for an organization that uses the file sharing system 504. For example, the pre-identified group may include users of a particular business unit, users of a particular team, users that have the same manager/supervisor, users that perform the same function (e.g., marketing, legal, IT, etc.), users that have the same employment status (e.g., temporary employees, part-time employees, etc.), etc.

In some implementations, based on the first data 106, the content control system 100 may store data associating or otherwise assigning the at least one portion of the first file 104 with the first user 108 or may store data indicating that the at least one portion of the first file 104 is to be made accessible to the first user 108.

At a step 124 of the routine 120, the content control system 100 may determine that the first file 104 is to be shared with the first user 108. The file owner 102 may, for example, provide an input via the file sharing application indicating that the first file 104 is to be shared with one or more users, including at least the first user 108. Based on determining that the first file 104 is to be shared with the first user 108, in some implementations, the content control system 100 may retrieve stored data associating the at least one portion of the first file 104 with the first user 108 or may store data indicating that the at least one portion of the first file 104 is to be made accessible to the first user 108.

At a step 126 of the routine 120, the content control system 100 may generate, based on the first data 106 (received at step 122) and the first file 104, a second file 110 including the at least one portion and excluding the other portions of the first file 104. The second file 110, thus, may only include portions of the first file 104 indicated by the file owner 102 to be made accessible to the first user 108. In some implementations, the content control system 100 may generate a masked file using the first data 106, where the masked file may be a copy of the first file 104 in which portions of the first file 104 are obscured or redacted so that those portions are inaccessible to the first user 108 according to the first data 106 received at the step 122.

At a step 128 of the routine 120, based on determining the first file 104 is to be shared with the first user 108, the content control system 100 may send, to the second client device 202b operated by the first user 108, the second file 110 so as to limit access, by the first user 108, to contents of the first file 104. In some implementations, the first user 108 may access the second file 110 at the second client device 202b without realizing that it includes only some portions of the first file 104 and not the entirety of the first file 104.

In some implementations, the first user 108 may request access to the first file 104 (e.g., request to download a copy of the first file 104), via a file sharing application at the second client device 202b. In response to such a request, the content control system 100 may send the second file 110 to the second client device 202b.

In a similar manner, the file owner 102 may limit access by the second user 114 to the contents of the first file 104, where the second user 114 may be allowed to access different portions of the first file 104 than the first user 108. In some implementations, the file owner 102 may be able to provide inputs limiting access to portions of the first file 104 for the first user 108 and the second user 114 using the same user interface screen and/or at substantially the same time. The content control system 100 may receive the first data 106 or separate data indicating at least another portion of the first file 104 is to be made accessible to the second user 114.

In some implementations, the file owner 102 may select portions of the first file 104 that a particular user is to be prevented from viewing. The user interface screen 166 of FIG. 1C illustrates such example selections by the file owner 102. Such selections may correspond to the first data 106 received by the content control system 100 at the step 122 of the routine 120. The user interface screen 166 may, for example, include a drop down menu 168a-b, to enable switching between types of selection the file owner 102 can provide. As shown in FIG. 1C, the drop down menu 168a may indicate “Do Not Allow to View,” in which a user is to be prevented from accessing the selected portions. The file owner 102 may select, using a mouse click and drag or an equivalent touch-screen input, one or more lines/sections of the displayed contents 165. As shown, the file owner 102 may select a first portion 169 of the contents 165, and may select a button 167 corresponding to a <username_1> for the first user 108 to indicate that the first user 108 is prevented from accessing the first portion 169. In response, the user interface screen 166 may update to display a selectable interface element 170 adjacent to the first portion 169 to indicate that the <username_1> is prevented from accessing the first portion 169. In some implementations, the file owner 102 may click the “X” in the element 170 to discard the indications that the <username_1> is prevented from accessing the first portion 169. In a similar manner, the file owner 102 may, within the same user interface screen 166, select a second portion 171 of the displayed contents 165, and may then select a button corresponding to <username_2>. In response, the user interface screen 166 may update to display a selectable interface element 172 adjacent to the second portion 171 to indicate that the <username_2> is prevented from accessing the second portion 171. Within the same user interface screen 166, the file owner 102 may further select a third portion 173 of the displayed contents 165, and may then select buttons corresponding to <username_3>, <username_1> and <group>. The user interface screen 166 may update to display selectable interface elements 174, 175, 176 adjacent to the third portion 173 to indicate that the <username_3>, <username_1> and <group> are prevented from accessing the third portion 173. As shown, a fourth portion 179 may not be associated with any users, and may thus be accessible by all users with whom the file is shared with.

FIGS. 1D and 1E illustrate contents of example files that may be generated based on the selections provided by the file owner 102 within the user interface screen 166 of FIG. 1C. The example files may be generated as part of the step 126 of the routine 120 shown in FIG. 1A. The content control system 100 may generate a file including contents 177 shown in FIG. 1D for the <username_1>. As such, the contents 177 do not include the first portion 169 and the third portion 173 shown in FIG. 1C, as the file owner 102 indicated that the <username_1> is to be prevented from accessing these portions. As shown in FIG. 1D, the contents 177 may include the second portion 171 and the fourth portion 179 of the contents 165 shown in FIG. 1C. The content control system 100 may generate another file including contents 178 shown in FIG. 1E for the <username_2>. As such, the contents 178 do not include the second portion 171 shown in FIG. 1C, as the file owner 102 indicated that the <username_2> is to be prevented from accessing this portion. As shown in FIG. 1E, the contents 178 may include the first portion 169, the third portion 173 and the fourth portion 179 of the contents 165 shown in FIG. 1C. To make the first file 104 available to the first user 108 associated with the <username_1>, the content control system 100 may send the file of FIG. 1D (e.g., the second file 110 shown in FIG. 1A) to the second client device 202b, and to make the first file 104 available to the second user 114 associated with the <username_2>, the content control system 100 may send the file of FIG. 1E (e.g., the third file 113 shown in FIG. 1A) to the third client device 202c.

In some implementations, the file owner 102 may select portions of the first file 104 that a particular user is allowed to access. An example user interface screen 180 shown in FIG. 1F illustrates such example selections by the file owner 102. Such selections may, for example, correspond to the first data 106 received by the content control system 100 at the step 122 of the routine 120. As shown in FIG. 1F, the drop down menu 168b may indicate “Only Allow to View,” in which a user is only allowed to access the selected portions. As shown, the file owner 102 may select a first portion 181 of the contents 165, and may select the button 167 corresponding to a <username_1> for the first user 108 to indicate that the first user 108 is to be able to access the first portion 181. The file owner 102, may similarly, select buttons for <username_2>, <username_3>, and <group>. In response, the user interface screen 180 may update to display selectable interface elements 182 adjacent to the first portion 181 to indicate that the <username_1>, <username_2>, <username_3>, and <group> are to be allowed to access the first portion 181. In a similar manner, the file owner 102 may, within the same user interface screen 180, select a second portion 183 of the displayed contents 165, and may then select buttons corresponding to <username_1> and <username_2>. In response, the user interface screen 180 may update to display selectable interface elements 184, 185 adjacent to the second portion 183 to indicate that the <username_1> and <username_2> are to be allowed to access the second portion 183. In a similar manner, the file owner 102 may, within the same user interface screen 180, select a third portion 186 of the displayed contents 165, and may then select buttons corresponding to <username_3> and <group>. In response, the user interface screen 180 may update to display selectable interface elements 187, 188 adjacent to the third portion 186 to indicate that the <username_3> and <group> are to be allowed to access the third portion 186.

FIGS. 1G and 1H illustrate contents of example files that may be generated based on the selections provided by the file owner 102 within the user interface screen 180 of FIG. 1F. The example files may be generated, for example, as part of the step 126 of the routine 120 shown in FIG. 1A. The content control system 100 may generate a file including contents 190 shown in FIG. 1G for the <username_1> and the <username_2>. As such, the contents 190 includes only the first portion 181 and the second portion 183 shown in FIG. 1C, as the file owner 102 indicated that the <username_1> and the <username_2> is allowed to access only these portions. The content control system 100 may generate another file including contents 191 shown in FIG. 1H for the <username_3> and the <group>. As such, the contents 191 includes only the first portion 181 and the third portion 186 shown in FIG. 1C, as the file owner 102 indicated that the <username_3> and the <group> is allowed to access only these portions. To make the first file 104 available to the first user 108 associated with the <username_1> and the second user 114 associated with the <username_2>, the content control system 100 may send the file of FIG. 1G to the second client device 202b and the third client device 202c, and to make the first file 104 available to a third user associated with the <username_3> and group of users associated with the <group>, the content control system 100 may send the file of FIG. 1H to a fourth client device 202 operated by the third user and a group of client devices 202 operated by the group of users.

In this manner, the content control system 100 enables the file owner 102 to efficiently and securely limit access to different portions of a file for different users. In making the file available to the recipient user(s), the content control system 100 maintains the original file so that the file owner 102 still has access to it, and generates separate files to send to the recipient user(s).

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

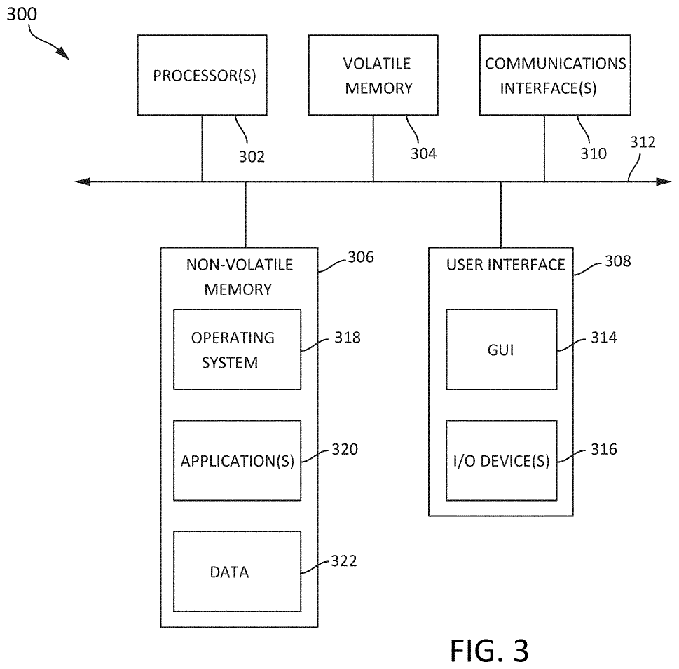

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

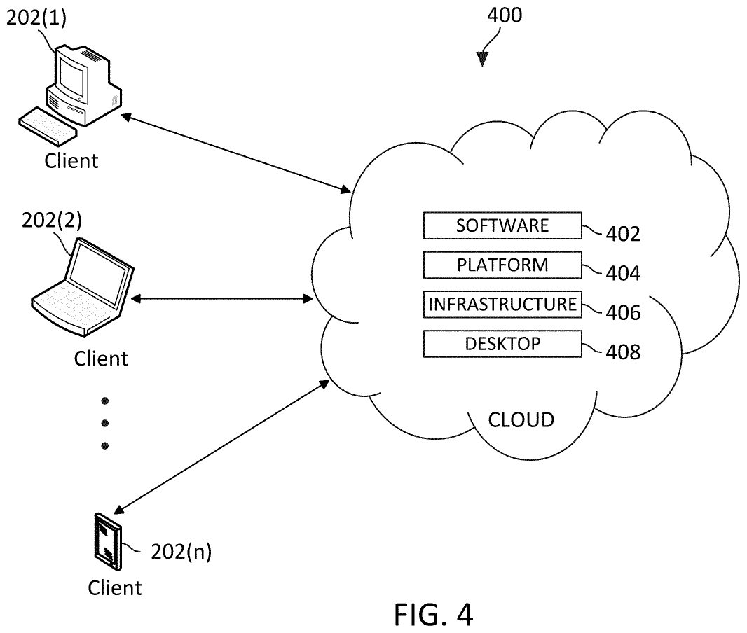

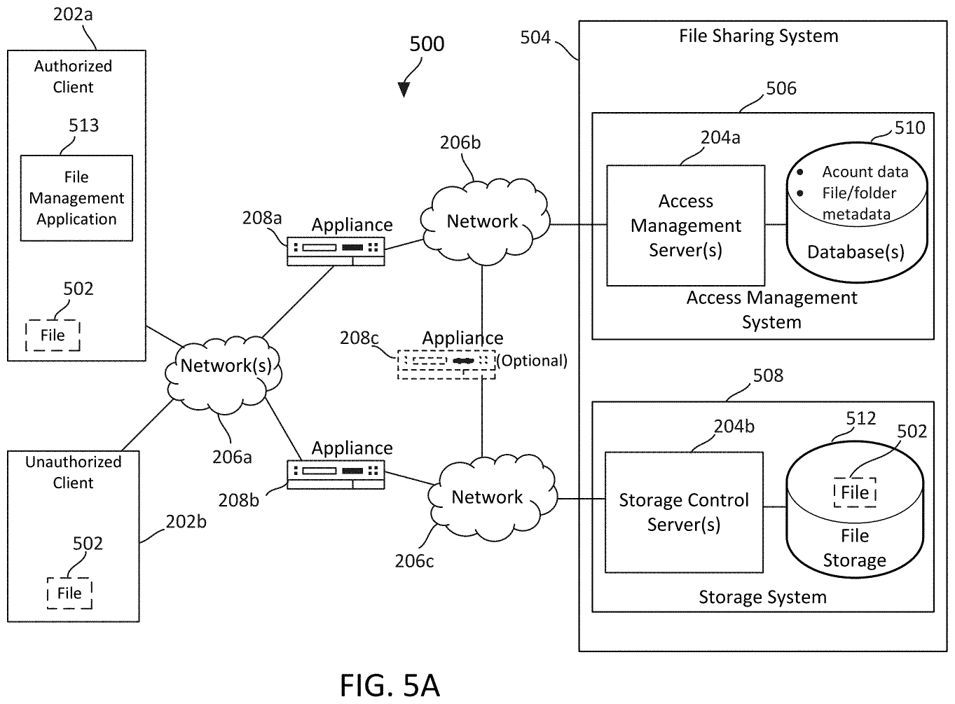

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Washington, for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

FIG. 5A shows an example network environment 500 for allowing an authorized client 202a and/or an unauthorized client 202b to upload a file 502 to a file sharing system 504 or download a file 502 from the file sharing system 504. The authorized client 202a may, for example, be a client 202 operated by a user having an active account with the file sharing system 504, while the unauthorized client 202b may be operated by a user who lacks such an account. As shown, in some embodiments, the authorized client 202a may include a file management application 513 with which a user of the authorized client 202a may access and/or manage the accessibility of one or more files 502 via the file sharing system 504. The file management application 513 may, for example, be a mobile or desktop application installed on the authorized client 202a (or in a computing environment accessible by the authorized client). The ShareFile® mobile app and the ShareFile® desktop app offered by Citrix Systems, Inc., of Fort Lauderdale, Fla., are examples of such preinstalled applications. In other embodiments, rather than being installed on the authorized client 202a, the file management application 513 may be executed by a web server (included with the file sharing system 504 or elsewhere) and provided to the authorized client 202a via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium(s) 512. In some embodiments, the access management server(s) 204a may, for example, allow a user of the file management application 513 to log in to his or her account, e.g., by entering a user name and password corresponding to account data stored in the database 510. Once the user of the client 202a has logged in, the access management server 204a may enable the user to view (via the authorized client 202a) information identifying various folders represented in the storage medium(s) 512, which is managed by the storage control server(s) 204b, as well as any files 502 contained within such folders. File/folder metadata stored in the database 510 may be used to identify the files 502 and folders in the storage medium(s) 512 to which a particular user has been provided access rights.

In some embodiments, the clients 202a, 202b may be connected to one or more networks 206a (which may include the Internet), the access management server(s) 204a may include webservers, and an appliance 208a may load balance requests from the authorized client 202a to such webservers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202a, 202b are shown is FIG. 5A as stand-alone computers, it should be appreciated that one or both of the clients 202a, 202b shown in FIG. 5A may instead represent other types of computing devices or systems that can be operated by users. In some embodiments, for example, one or both of the authorized client 202a and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202a, 202b received from the network(s) 206a (which may include the Internet) to the storage control server(s) 204b. In some embodiments, the storage control server(s) 204b and/or the storage medium(s) 512 may be hosted by a cloud-based service provider (e.g., Amazon Web Services™ or Microsoft Azure™). In other embodiments, the storage control server(s) 204b and/or the storage medium(s) 512 may be located at a data center managed by an enterprise of a client 202, or may be distributed among some combination of a cloud-based system and an enterprise system, or elsewhere.

After a user of the authorized client 202a has properly logged in to an access management server 204a, the server 204a may receive a request from the client 202a for access to one of the files 502 or folders to which the logged in user has access rights. The request may either be for the authorized client 202a to itself to obtain access to a file 502 or folder or to provide such access to the unauthorized client 202b. In some embodiments, in response to receiving an access request from an authorized client 202a, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202a, and the authorized client 202a may then send a request for a file 502, including the token, to the storage control server(s) 204b. In other implementations, the authorized client 202a may send the generated token to the unauthorized client 202b so as to allow the unauthorized client 202b to send a request for the file 502, including the token, to the storage control server(s) 204b. In yet other implementations, an access management server 204a may, at the direction of the authorized client 202a, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202a to send a request to the URL address, or by sending an email, text message or other communication including the token-containing URL to the unauthorized client 202b, either directly from the access management server(s) 204a or indirectly from the access management server(s) 204a to the authorized client 202a and then from the authorized client 202a to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202a or an unauthorized client 202b to upload a file 502 to a folder corresponding to the token. In some embodiments, for example, an “upload” token can be generated as discussed above when an authorized client 202a is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user's that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium(s) 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

### F. Detailed Description of Example Embodiments of System for Providing User-Based Access to Content of Files

As described above in Section A, at a high level, the content control system 100 (shown in FIG. 1A) may enable a file owner to limit access, at a user level, to contents of a file shared with multiple users. As explained, in some implementations, the content control system 100 may cause the first client device 202a operated by the file owner 102 to display contents of the first file 104 to enable the file owner 102 to control access to the contents of the first file 104. The content control system 100 may receive first data 106 (based on input from the file owner 102) indicating which portions of the first file 104 are to be made accessible to which users with whom the first file 104 is shared with. To make the first file 104 accessible to a first recipient (e.g., the first user 108 or the second user 114 shown in FIG. 1A), the content control system 100, may generate another file (e.g., the second file 110 or the third file 113 shown in FIG. 1A) that includes the portions of the first file 104 that the first data 106 indicates are to be accessible by the first recipient, and may send the generated file to a client device 202 operated by the first recipient.

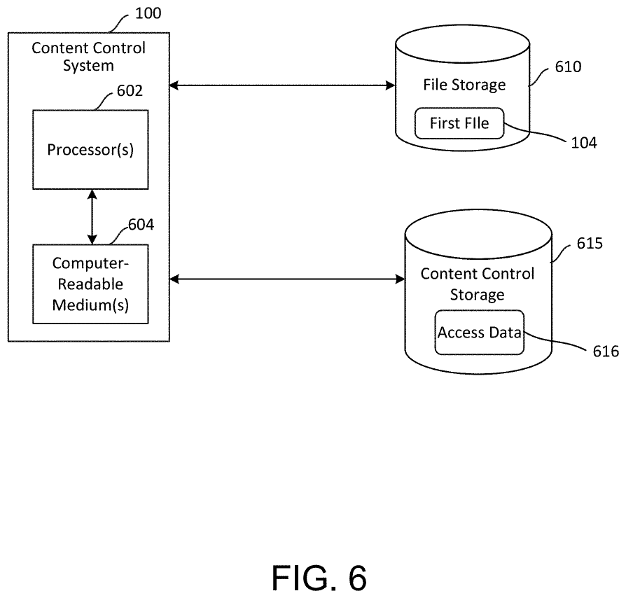

FIG. 6 illustrates an example implementation of the content control system 100 introduced in Section A. As shown, in some implementations, the content control system 100 may include one or more processors 602 as well as one or more computer-readable mediums 604 that are encoded with instructions to be executed by the processor(s) 602. In some implementations, such instructions may cause the processor(s) 602 to implement one or more, or possibly all, of the operations of the content control system 100 described herein. The content control system 100 may be in (wired or wireless) communication with a file storage 610 that may store the first file 104. The content control system 100 may also be in communication with a content control storage 615 that may store access data 616 indicating which portions of the first file 104 are to be made accessible to which users. In some implementations, the first file 104 and the access data 616 may be stored in different storage mediums. In other implementations, the first file 104 and the access data 616 may be stored in the same storage medium.

The processor(s) 602 and computer-readable medium(s) 604 may be disposed at any of a number of locations within a computing network such as the network environment 200 described above (in Section B) in connection with FIG. 2. The storage medium(s) 610 and 615 shown in FIG. 6 may likewise be disposed at any of a number of locations within such a computing network in a distributed architecture or other fashion. In some implementations, for example, the processor(s) 602 and the computer-readable medium(s) 604 embodying one or more such components may be located within one or more of the servers 204 and/or the computing system 300 that are described above (in Sections B and C) in connection with FIGS. 2 and 3, and/or may be located within a cloud computing environment 400 such as that described above (in Section D) in connection with FIG. 4.

In some implementations, the content control system 100 may be part of the file sharing system 504 described in relation to FIGS. 5A-5C in Section E above. In such implementations, the file storage 610 may, for example, correspond to the file storage medium(s) 512 of the storage system 508 of the file sharing system 504 shown in FIGS. 5A-5C. In such implementations, the content control storage 615 may be included in the access management system 506 of the file sharing system 504. In some implementations, for example, the access data 616 may be included in the database(s) 510 of the access management system 506. In some implementations, some or all of the functionality of the content control system 100 may be implemented by the storage system 508. In other implementations, some or all of the functionality of the content control system 100 may additionally or alternatively be implemented by the access management system 506.

As described above in (Section E) in connection with FIGS. 5A-5C, the storage medium(s) 512 may store files 502 uploaded to the file sharing system 504 by multiple different users, including the first file 104 which may be uploaded by the file owner 102. As described above in (Section E) in connection with FIGS. 5A-5C, the database(s) 510 may store information used to process user requests, and may store file metadata associated with the files 502. One of the user requests may be a request to control access to contents of the first file 104 by one or more users, and one of the types of information stored in the database(s) 510 may be the access data 616 indicating which recipient users are allowed to access which portions of the first file 104.

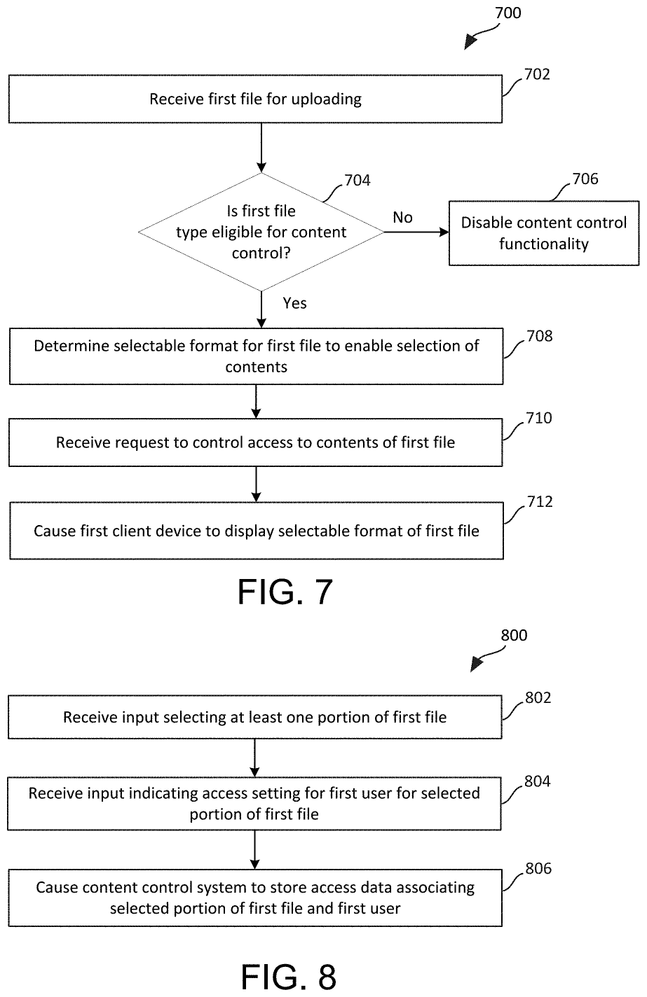

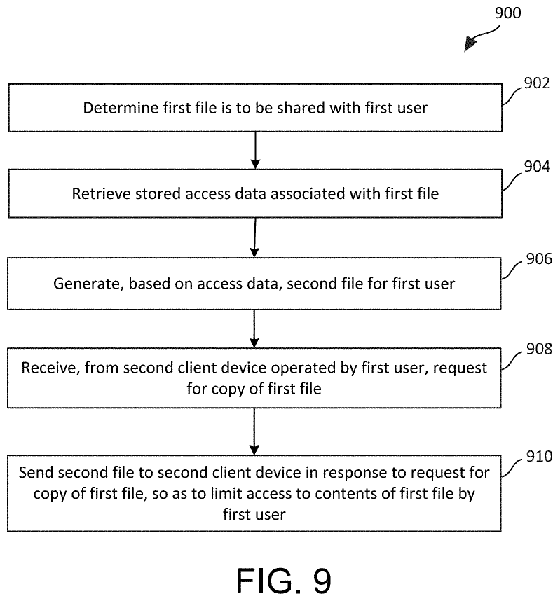

FIG. 7 shows a first example routine 700 that may be performed by the content control system 100 for displaying contents of the first file 104 at a client device 202a to enable the file owner 102 to provide inputs indicating which portions of the first file 104 are to be made accessible by which users. FIG. 8 shows an example routine 800 that may be performed by the client device 202a for determining the first data 106 indicating which portions of the first file 104 are accessible by which users, and for causing the content control storage 615 to store the first data 106 (e.g., as the access data 616 shown in FIG. 6). FIG. 9 shows a second example routine 900 that may be performed by the content control system 100 for sharing a file, generated from the first file 104, with a user based on the first data 106 provided by the file owner 102.

Referring to FIG. 7, at a step 702 of the routine 700, the content control system 100 may receive the first file 104 for uploading. In the case where the content control system 100 is part of the file sharing system 504 (described in connection with FIGS. 5A-C), the file owner 102 operating the client device 202a may have sent a request to upload the file 104 (e.g., to a particular folder managed by the file owner 102) to the access management system 506, and the access management system 506 may have provided the client device 202a with an upload token (e.g., obtained from the storage system 508 per the step 520 shown in FIG. 5C) as well as a link to the storage system 508. The client device 202a may then have used that link and upload token to upload the first file 104 to the storage system 508. Thus, in such implementations, the step 702 may be performed by the storage system 508.

At a decision step 704 of the routine 700, the content control system 100 may determine whether the first file 104 is of a type that is eligible for content control according to operations described herein. In some implementations, the content control system 100 may be configured to enable content access control for different types of files, such as a file that includes only text and/or images or a file that can be converted to text and images. For example, the content control system 100 may determine that files are eligible for content control if the files have one of the following extensions: .doc, .docx, .ppt, .pdf, .rtf, .txt, or .xlsx. In some implementations, the content control system 100 may determine that files are eligible for content control if the file is of an Open XML format. Additionally or alternatively, the content control system 100 may determine that files are eligible for content control if the files can be converted to text and image using a file conversion service. In yet other implementations, the content control system 100 may determine that files are eligible for content control if the files can be opened using a particular application, such as, Microsoft® Word, Microsoft® PowerPoint®, Microsoft® Excel, or Adobe® applications. In yet other implementations, other methods may be used to determine if the first file 104 is eligible for content control.

If the first file 104 is not eligible for content control, then at a step 706 of the routine 700, the content control system 100 may disable the content control functionality. For example, the button 162 of the user interface screen 160 shown in FIG. 1B may be disabled, so that the file owner 102 is not able to select it for the first file 104. In implementations in which the content control system 100 is part of the file sharing system 504 (described in connection with FIGS. 5A-C), the content control functionality for the file 104 may be disabled, for example, by altering the metadata for the first file 104 (e.g., within the database(s) 510) to indicate that the file 104 is not enabled for the content control functionality described herein.

If the first file 104 is eligible for content control, then at a step 708 of the routine 700, the content control system 100 may determine a selectable format for the first file 104 to enable selection of contents. In determining the selectable format, the content control system 100 may convert contents of the first file 104 to text and images, and may assign a reference number or identifier to individual portions of the contents. For example, the content control system 100 may assign a line number to each line of text and an image number to each image of the first file 104. As another example, the content control system 100 may assign a paragraph number to each paragraph of the first file 104. As another example, the content control system 100 may assign a section number to different sections of the first file 104 or to a group of text of the first file 104. In some implementations, in determining the selectable format, the content control system 100 may convert the first file 104 to a .docx format, and then assign the identifiers to portions of the contents. In implementations in which the content control system 100 is part of the file sharing system 504 (described in connection with FIGS. 5A-C), the step 708 may be performed, for example, by a component of the storage system 508, and data indicative of the determined selectable format may be stored in association with the first file 104 (e.g., within the file storage medium(s) 512).

At a step 710 of the routine 700, the content control system 100 may receive a request to control access to contents of the first file 104. Such a request may be received, for example, from the first client device 202a operated by the file owner 102. For example, the file owner 102 may select the first file 104 via the user interface screen 160 shown in FIG. 1B, and then select the button 162 on that screen to indicate that the file owner 102 wants to control access for the first file 104. In implementations in which the content control system 100 is part of the file sharing system 504 (described in connection with FIGS. 5A-C), the step 710 may be performed by a component of the access management system 506. For example, the access management system 506 may have delivered the user interface screen 160 to the client device (via the file management application 513) in response to commands input by the file owner 102, and the file owner 102 may have selected the button 162 on that user interface screen 160, thereby causing the client device 202a to send the access control request to the access management system 506.

At a step 712 of the routine 700, the content control system 100 may cause the first client device 202a to display the content of the first file 104 in the selectable format determined at the step 708. The content control system 100 may cause display of the selectable format in response to the request received at the step 710. The user interface screen 166 shown in FIG. 1C and the user interface screen 180 shown in FIG. 1F are examples of the selectable format of the first file 104 that may be displayed at the first client device 202a. In some implementations, the identifiers (e.g., line numbers, image numbers, paragraph numbers, section numbers, etc.) for the text and images of the first file 104 may also be displayed at the first client device 202a. In other implementations, the identifiers may only be used internally by the content control system 100 to identify which portions of the first file 104 are selected by the file owner 102.

In implementations in which the content control system 100 is part of the file sharing system 504 (described in connection with FIGS. 5A-C), the step 712 may be performed by a combination of the access management system 506 and the storage system 508. For example, in response to receiving the request at the step 710, the access management system 506 may instruct the storage system 508 to prepare the content of the first file 104, in the selectable format determined at the step 708, for delivery to the client device 202a, e.g. similar to the step 516 shown in FIG. 5C. In response to such an instruction, the storage system 508 may return an access token for the prepared content to the access management system 506, e.g., similar to the step 520 shown in FIG. 5C. The access management system 506 may then send that access token to the client device 202a along with a link that can be used to retrieve the prepared content from the storage system 508, e.g., similar to the step 522 shown in FIG. 5C. The file management application 513 on the client device 202a may then use that access token and link to retrieve the prepared content from the storage system 508 and present the content of the first file 104 in the selectable format, e.g., as shown in FIG. 1C or FIG. 1F. In other implementations, the storage system 508 may send, to the client device 202a, a link to retrieve the prepared content from the storage system 508 and present the content of the first file 104 in the selectable format, e.g., as shown in FIG. 1C or FIG. 1F.

Referring now to FIG. 8, at a step 802 of the routine 800, the client device 202a may receive an input selecting at least one portion of the first file 104. The file owner 102 may, for example, select the text and images displayed at the first client device 202a by using a mouse click and drag or an equivalent touch-screen input. The text and images may be displayed at the first client device 202a as described above in relation to the routine 700.

At a step 804 of the routine 800, the client device 202a may receive an input indicating an access setting for the first user 108 for the selected portion of the first file 104. The file owner 102 may, for example, select a username associated with the first user 108, as described in relation to FIG. 1C. The file owner 102 may also indicate whether the first user 108 is to be allowed to access the selected portion of the first file 104 or is to be prevented from accessing the selected portion of the first file 104. As described in relation to FIG. 1C above, the file owner 102 may, for example, use the drop down menu 168 to indicate whether the first user 108 is to be able to access the selected portion or is to be prevented from accessing the selected portion.

In some cases, the input received at the step 804 may indicate an access setting for a group of users for the selected portion of the first file 104. The group of users may be identified by a group name, which may be created by the file owner 102 to include a set of users. In other implementations, the group of users may be a pre-identified group for an organization based on certain characteristics of the users. For example, the pre-identified group may include users of a particular business unit, users of a particular team, users that have the same manager/supervisor, users that perform the same function (e.g., marketing, legal, IT, etc.), users that have the same employment status (e.g., temporary employees, part-time employees, etc.), etc.

At a step 806 of the routine 800, the client device 202a may cause the content control system 100 to store access data 616 associating the selected portion of the first file 104 and the first user 108. The access data 616 may include a username or another identifier for the first user 108, and may include the identifiers (e.g., line numbers, image numbers, paragraph numbers, section numbers, etc.) for the selected portion of the first file 104. The access data 616 may also include an access indication, based on whether the file owner 102 indicated that the first user 108 is able to access the selected portion or is prevented from accessing the selected portion. For example, if the selected portion is accessible by the first user 108, then the access data 616 may include a “visible” indication. As another example, if the selected portion is not accessible by the first user 108, then the access data 616 may include a “restrictive” indication. The access data 616 may be associated with the first file 104 or with a file identifier for the first file 104.

In the case that the selected portion is to be made accessible to a group of users, the access data 616 may include an identifier for the group, or may include identifiers for different or individual users in the group, and may associate the appropriate access indication and the selected portion with the group identifier or the user identifiers for the users in the group.

In implementations in which the content control system 100 is part of the file sharing system 504 (described in connection with FIGS. 5A-C), the client device 202a may perform the step 806 by sending the first data 106 (shown in FIG. 1A) to the access management system 506, so as to cause the access management system 506 to store the first data 106, e.g., as the access data 616 shown in FIG. 6. In some implementations, the first data 106 does not include the content of the first file 104 and instead includes only indicators of portions of the first file (e.g., line number, page numbers, section numbers, etc.) that are to be included and/or excluded from versions of the first file 104 that are subsequently provided to other particular users and/or groups of users.

As described in relation to FIG. 1A and as illustrated in FIG. 1C, the file owner 102 may select multiple different portions of the first file 104, and may indicate an access setting for multiple different users. In some implementations, the content control system 100 may store, in the content control storage 615, separate access data, associated with the first file 104, for individual users indicated by the file owner 102. For example, the content control system 100 may store first access data for the first user 108 and second access data for the second user 114. In other implementations, the access data 616 may include access information all users (e.g., the first user 108 and the second user 114) indicated by the file owner 102.

At a step 902 of the routine 900, the content control system 100 may determine that the first file 104 is to be shared with another user, e.g., the first user 108 or the second user 114 shown in FIG. 1A. The content control system 100 may make this determination, for example, based on an input from the file owner 102 while or after uploading the first file 104 to the file sharing system 504. Alternatively, the file owner 102 may provide an input indicating the first file 104 is to be shared with the first user 108 after providing the inputs that indicate the access settings for the first user 108, as described in relation to the routine 800. In implementations in which the content control system 100 is part of the file sharing system 504 (described in connection with FIGS. 5A-C), the step 902 may be performed by the access management system 506 when a request to share a file with one or more other users is received from the client device 202a, e.g., per the step 514 as shown in FIG. 5C.

At a step 904 of the routine 900, the content control system 100 may retrieve the stored access data 616, from the content control storage 615, associated with the first file 104. In implementations in which the content control system 100 is part of the file sharing system 504 (described in connection with FIGS. 5A-C), the step 904 may be performed, for example, by the access management system 506 in response to recipe of the file sharing request from the client device 202a.

At a step 906 of the routine 900, the content control system 100 may generate, based on the access data 616, a second file (e.g., the second file 110 shown in FIG. 1A) for the first user 108. The second file 110 may include portions of the first file 104 that are accessible by the first user 108 as indicated by the access data 616. The third file 113 may include portions of the first file 104 that are accessible by the second user 114 as indicated by the access data 616. The content control system 100 may use the identifiers (line numbers, image numbers, paragraph numbers, section numbers, etc.) included in the access data 616 to extract the appropriate portions of the first file 104 and insert them in the second file 110. In other implementations, the content control system 100 may copy the contents of the first file 104 into the second file 110 and may use the identifiers from the access data 616 to remove portions that are not accessible by the first user 108. In some embodiments, the content control system 100 may use a .docx format of the first file 104 to copy portions of the first file 104 into the second file 110, and then convert the second file 110 so that the format of the second file 110 matches the original format/file extension of the first file 104 as when it was uploaded. In implementations in which the content control system 100 is part of the file sharing system 504 (described in connection with FIGS. 5A-C), the step 906 may be performed by the storage system 508 when the storage system 508 receives a request from the access management system 506 to prepare a file for sharing (e.g., per the step 516 shown in FIG. 5C).

At a step 908 of the routine 900, the content control system 100 may receive, from the second client device 202b operated by the first user 108, a request for a copy of the first file 104. For example, the first user 108 may receive an indication (e.g., a notification, an email, a message, etc.) that the file owner 102 shared the first file 104 with the first user 108. The first user 108 may click a link included in the notification, email or message, to download a copy of the first file 104. In implementations in which the content control system 100 is part of the file sharing system 504 (described in connection with FIGS. 5A-C), the step 908 may be performed by the storage system 508 when the storage system 508 receives a file download request and associated download token from the first client device 202b, e.g., per the step 524 shown in FIG. 5C. In such implementations, after generating the second file 110, the storage system 508 may have sent a download token for the second file to the access management system 506, and the access management system 506 may have provided such a token, as well as a link to the second file 110 on the storage system 508, to the second client 202b, either directly or indirectly, e.g., using any of the file sharing techniques described above.

At a step 910 of the routine 900, the content control system 100 may send the second file 110 to the second client device 202b in response to the request for the copy of the first file 104, so as to limit access to contents of the first file 104 by the first user 108. In implementations in which the content control system 100 is part of the file sharing system 504 (described in connection with FIGS. 5A-C), the step 910 may be performed by the storage system 508, when it sends the second file 110 to the second client device 202b, e.g., per the step 528 shown in FIG. 5C, in response to receipt of the download token from the second client device 202b, e.g., per the step 524 shown in FIG. 5C.

In the case that the access data 616 indicates an access setting for a group of users (e.g., users that are temporary employees), the content control system 100 may determine whether a user requesting a copy of the first file 104 is part of the group of users. For example, the content control system 100 may determine if the requesting user is associated with the group identifier, using organization structure data or other external data defining which users are included in which groups of users. If the requesting user is part of the group of users, then the content control system 100 may generate a file including the portions that are made accessible to the group of users, and send the generated file to a client device 202 operated by the requesting user.

As described herein, in some cases, the file owner 102 may set access settings for multiple users with whom the first file 104 is to be shared with. In some cases, the file owner 102 may indicate the multiple users that the first file 104 is to be shared in a single instance or using the same user interface. As such, at the step 902 of the routine 900, the content control system 100 may determine that the first file 104 is to be shared with multiple users, including the first user 108 and the second user 114. The access data 616, retrieved at the step 904, may also indicate portions of the first file 104 that are accessible by the second user 114. Based on this information, the content control system 100 may generate a third file that includes portions of the first file 104 that the second user 114 is allowed to access. The content control system 100 may receive a request, from the third client device 202c operated by the second user 114, for a copy of the first file 104, and in response to the request, the content control system 100 may send the third file to the third client device 202c, so as to limit access to the contents of the first file 104 by the second user 114. As such, the file owner 102 can share the first file 104 with multiple users, and the content control system 100 sends the appropriate file to the respective user.

In some cases, the file owner 102 may want to share the entire first file 104 with a user (e.g., a third user). In such cases, the file owner 102 may not provide any inputs, as described in relation to the routine 800, with respect to the third user. As such, access data 616 stored by the content control system 100 for the first file 104 may not include a username for the third user and may not include any association between the third user and portions of the first file 104. When a request for a copy of the first file 104 is received from the third user, the content control system 100 may recognize that there is no access setting information in the access data 616 for the third user, and may then send a copy of the first file 104 to a client device 202 operated by the third user.

In this manner, a file owner can efficiently share different portions of a file with different users on a user-by-user basis. The system described herein enables the file owner to provide access settings for different users within the same interface, and the system automatically generates a file with the appropriate portions for sharing with the respective user.

G. Example Implementations of Methods, Systems, and Computer-Readable Media in Accordance with the Present Disclosure

The following paragraphs (M1) through (M12) describe examples of methods that may be implemented in accordance with the present disclosure.

(M1) A method may involve receiving, by a computing system and from a first client device operated by an owner of a first file, an input indicative of at least one portion of the first file is to be made accessible to a first user, determining that the first file is to be shared with the first user, generating, by the computing system based on the input from the first client device and the first file, a second file including the at least one portion of the first file and excluding other portions of the first file, and based on determining that the first file is to be shared with the first user, sending, by the computing system to a second client device operated by the first user, the second file so as to limit access, by the first user, to content of the first file.

(M2) A method may be performed as described in paragraph (M1), and may further involve, based on the input from the first client device, storing, by the computing system, first data associating the at least one portion of the first file with the first user.

(M3) A method may be performed as described in paragraph (M2), and may further involve, based on determining that the first file is to be shared with the first user, retrieving the first data, and generating the second file based on retrieving the first data.

(M4) A method may be performed as described in any of paragraphs (M1) through (M3), wherein the first file is to be shared with a second user, and the method may further involve determining, by the computing system, second data indicative of at least another portion of the first file to be made accessible to the second user, the second data being indicated by the owner of the first file, generating, by the computing system and based on the second data and the first file, a third file including the at least another portion and excluding other portions of the first file, and based on determining that the first file is to be shared with the second user, sending, by the computing system to a third client device operated by the second user, the third file so as to limit access, by the second user, to content of the first file.

(M5) A method may be performed as described in any of paragraphs (M1) through (M4), and may further involve receiving, by the computing system and from the second client device, a request to access the first file, and wherein the second file is generated in response to receiving the request from the second client device.

(M6) A method may be performed as described in any of paragraphs (M1) through (M5), and may further involve receiving, by the computing system and from the first client device, a request to limit access to content of the first file, and causing, by the computing system, the first client device to display the content of the first file to enable selection of the at least one portion of the first file and enable indication of at least the first user that is allowed to access the selected at least one portion of the first file.

(M7) A method may be performed as described in any of paragraphs (M1) through (M6), and may further involve receiving, by the computing system and from the first client device, the first file.

(M8) A method may be performed as described in any of paragraphs (M1) through (M7), wherein the input received from the first client device further indicates at least another portion of the first file is to be made accessible to a second user.

(M9) A method may be performed as described in any of paragraphs (M1) through (M8), and may further involve receiving, by the computing system and from the first client device, an additional input indicative of at least another portion of the first file is to be made accessible to a group of users, generating, by the computing system based on the additional input and the first file, a third file including the at least another portion of the first file and excluding other portions of the first file, and sending, by the computing system to at least a third client device operated by a second user of the group of users, the third file so as to limit access, by the second user, to content of the first file.

(M10) A method may involve receiving, by a computing system and from a first client device operated by a first user, a request for a copy of a first file, determining, by the computing system, first data indicative of at least one portion of the first file is to be made accessible to the first user, the first data being indicated by an owner of the first file, generating, by the computing system and based on the first data, a second file including the at least one portion of the first file and excluding other portions of the first file, and in response to the request for the copy of the first file, sending, by the computing system to the first client device, the second file so as to limit access, by the first user, to content of the first file.

(M11) A method may be performed as described in paragraph (M10), and may further involve receiving, by the computing system and from a second client device, a request for the copy of the first file, determining, by the computing system, second data indicative of at least another portion of the first file is to be made accessible to a second user, the second data being indicated by the owner of the first file, generating, by the computing system and based on the second data, a third file including the at least another portion of the first file and excluding other portions of the first file, and in response to the request for the copy of the first file, sending, by the computing system to the second client device, the third file so as to limit access, by the second user, to content of the first file.

(M12) A method may be performed as described in paragraph (M10) or paragraph (M11), and may further involve receiving, by the computing system and from a second client device operated by the owner of the first file, an input indicative of the at least one portion of the first file to be made accessible to the first user, and storing the first data based on receipt of the input from the second client device.

The following paragraphs (S1) through (S12) describe examples of systems and devices that may be implemented in accordance with the present disclosure.

(S1) A computing system may comprise at least one processor and at least one computer-readable medium encoded with instructions which, when executed by the at least one processor, cause the computing system to receive, from a first client device operated by an owner of a first file, an input indicative of at least one portion of the first file is to be made accessible to a first user, determine that the first file is to be shared with the first user, generate, based on the input from the first client device and the first file, a second file including the at least one portion of the first file and excluding other portions of the first file, and based on determining that the first file is to be shared with the first user, send, to a second client device operated by the first user, the second file so as to limit access, by the first user, to content of the first file.

(S2) A computing system may be configured as described in paragraph (S1), and the at least one computer-readable medium may be encoded with additional instructions which, when executed by the at least one processor, further cause the computing system to, based on the input from the first client device, store first data associating the at least one portion of the first file with the first user.

(S3) A computing system may be configured as described in paragraph (S2), and the at least one computer-readable medium may be encoded with additional instructions which, when executed by the at least one processor, further cause the computing system to, based on determining that the first file is to be shared with the first user, retrieve the first data, and generate the second file based on retrieving the first data.

(S4) A computing system may be configured as described in any of paragraphs (S1) through paragraph (S3), wherein the first file is to be shared with a second user, and the at least one computer-readable medium may be encoded with additional instructions which, when executed by the at least one processor, further cause the computing system to determine second data indicative of at least another portion of the first file to be made accessible to the second user, the second data being indicated by the owner of the first file, generate, based on the second data and the first file, a third file including the at least another portion and excluding other portions of the first file, and based on determining that the first file is to be shared with the second user, send, to a third client device operated by the second user, the third file so as to limit access, by the second user, to content of the first file.

(S5) A computing system may be configured as described in any of paragraphs (S1) through (S4), and the at least one computer-readable medium may be encoded with additional instructions which, when executed by the at least one processor, further cause the computing system to receive, from the second client device, a request to access the first file, and wherein the second file is generated in response to receiving the request from the second client device.

(S6) A computing system may be configured as described in any of paragraphs (S1) through (S5), and the at least one computer-readable medium may be encoded with additional instructions which, when executed by the at least one processor, further cause the computing system to receive, from the first client device, a request to limit access to content of the first file, and cause the first client device to display the content of the first file to enable selection of the at least one portion of the first file and enable indication of at least the first user that is allowed to access the selected at least one portion of the first file.

(S7) A computing system may be configured as described in any of paragraphs (S1) through (S6), and the at least one computer-readable medium may be encoded with additional instructions which, when executed by the at least one processor, further cause the computing system to receive, from the first client device, the first file.

(S8) A computing system may be configured as described in any of paragraphs (S1) through (S7), wherein the input received from the first client device further indicates at least another portion of the first file is to be made accessible to a second user.

(S9) A computing system may be configured as described in any of paragraphs (S1) through (S8), and the at least one computer-readable medium may be encoded with additional instructions which, when executed by the at least one processor, further cause the computing system to receive, from the first client device, an additional input indicative of at least another portion of the first file is to be made accessible to a group of users, generate, based on the additional input and the first file, a third file including the at least another portion of the first file and excluding other portions of the first file, and send, to at least a third client device operated by a second user of the group of users, the third file so as to limit access, by the second user, to content of the first file.

(S10) A computing system may comprise at least one processor and at least one computer-readable medium encoded with instructions which, when executed by the at least one processor, cause the computing system to receive, from a first client device operated by a first user, a request for a copy of a first file, determine first data indicative of at least one portion of the first file is to be made accessible to the first user, the first data being indicated by an owner of the first file, generate, based on the first data, a second file including the at least one portion of the first file and excluding other portions of the first file, and in response to the request for the copy of the first file, send, to the first client device, the second file so as to limit access, by the first user, to content of the first file.

(S11) A computing system may be configured as described in paragraph (S10), wherein the at least one computer-readable medium may be encoded with additional instruction which, when executed by the at least one processor, further cause the computing system to receive, from a second client device, a request for the copy of the first file, determine, by the computing system, second data indicative of at least another portion of the first file is to be made accessible to a second user, the second data being indicated by the owner of the first file, generate, based on the second data, a third file including the at least another portion of the first file and excluding other portions of the first file, and in response to the request for the copy of the first file, send, to the second client device, the third file so as to limit access, by the second user, to content of the first file.

(S12) A computing system may be configured as described in paragraph (S10) or paragraph (S11), wherein the at least one computer-readable medium may be encoded with additional instruction which, when executed by the at least one processor, further cause the computing system to receive, from a second client device operated by the owner of the first file, an input indicative of the at least one portion of the first file to be made accessible to the first user, and store the first data based on receipt of the input from the second client device.

The following paragraphs (CRM1) through (CRM12) describe examples of computer-readable media that may be implemented in accordance with the present disclosure.

(CRM1) At least one non-transitory computer-readable medium may be encoded with instructions which, when executed by at least one processor of a computing system, cause the computing system to receive, from a first client device operated by an owner of a first file, an input indicative of at least one portion of the first file is to be made accessible to a first user, determine that the first file is to be shared with the first user, generate, based on the input from the first client device and the first file, a second file including the at least one portion of the first file and excluding other portions of the first file, and based on determining that the first file is to be shared with the first user, send, to a second client device operated by the first user, the second file so as to limit access, by the first user, to content of the first file.

(CRM2) At least one non-transitory computer-readable medium may be configured as described in paragraph (CRM1), and may be encoded with additional instruction which, when executed by the at least one processor, further cause the computing system to, based on the input from the first client device, store first data associating the at least one portion of the first file with the first user.

(CRM3) At least one non-transitory computer-readable medium may be configured as described in paragraph (CRM2), and may be encoded with additional instruction which, when executed by the at least one processor, further cause the computing system to, based on determining that the first file is to be shared with the first user, retrieve the first data, and generate the second file based on retrieving the first data.

(CRM4) At least one non-transitory computer-readable medium may be configured as described in any of paragraphs (CRM1) through (CRM3), wherein the first file is to be shared with a second user, and may be encoded with additional instruction which, when executed by the at least one processor, further cause the computing system to determine second data indicative of at least another portion of the first file to be made accessible to the second user, the second data being indicated by the owner of the first file, generate, based on the second data and the first file, a third file including the at least another portion and excluding other portions of the first file, and based on determining that the first file is to be shared with the second user, send, to a third client device operated by the second user, the third file so as to limit access, by the second user, to content of the first file.

(CRM5) At least one non-transitory computer-readable medium may be configured as described in any of paragraphs (CRM1) through (CRM0), and may be encoded with additional instruction which, when executed by the at least one processor, further cause the computing system to receive, from the second client device, a request to access the first file, and wherein the second file is generated in response to receiving the request from the second client device.

(CRM6) At least one non-transitory computer-readable medium may be configured as described in any of paragraphs (CRM1) through (CRM5), and may be encoded with additional instruction which, when executed by the at least one processor, further cause the computing system to receive, from the first client device, a request to limit access to content of the first file, and cause the first client device to display the content of the first file to enable selection of the at least one portion of the first file and enable indication of at least the first user that is allowed to access the selected at least one portion of the first file.

(CRM7) At least one non-transitory computer-readable medium may be configured as described in any of paragraphs (CRM1) through (CRM6), and may be encoded with additional instruction which, when executed by the at least one processor, further cause the computing system to receive, from the first client device, the first file.

(CRM8) At least one non-transitory computer-readable medium may be configured as described in any of paragraphs (CRM1) through (CRM7), wherein the input received from the first client device further indicates at least another portion of the first file is to be made accessible to a second user.

(CRM9) At least one non-transitory computer-readable medium may be configured as described in any of paragraphs (CRM1) through (CRM8), and may be encoded with additional instruction which, when executed by the at least one processor, further cause the computing system to receive, from the first client device, an additional input indicative of at least another portion of the first file is to be made accessible to a group of users, generate, based on the additional input and the first file, a third file including the at least another portion of the first file and excluding other portions of the first file, and send, to at least a third client device operated by a second user of the group of users, the third file so as to limit access, by the second user, to content of the first file.

(CRM10) At least one non-transitory computer-readable medium may be encoded with instructions which, when executed by at least one processor of a computing system, cause the computing system to receive, from a first client device operated by a first user, a request for a copy of a first file, determine first data indicative of at least one portion of the first file is to be made accessible to the first user, the first data being indicated by an owner of the first file, generate, based on the first data, a second file including the at least one portion of the first file and excluding other portions of the first file, and in response to the request for the copy of the first file, send, to the first client device, the second file so as to limit access, by the first user, to content of the first file.

(CRM11) At least one non-transitory computer-readable medium may be configured as described in paragraph (CRM10), and may be encoded with additional instruction which, when executed by the at least one processor, further cause the computing system to receive, from a second client device, a request for the copy of the first file, determine, by the computing system, second data indicative of at least another portion of the first file is to be made accessible to a second user, the second data being indicated by the owner of the first file, generate, based on the second data, a third file including the at least another portion of the first file and excluding other portions of the first file, and in response to the request for the copy of the first file, send, to the second client device, the third file so as to limit access, by the second user, to content of the first file.

(CRM12) At least one non-transitory computer-readable medium may be configured as described in paragraph (CRM10) or paragraph (CRM11), and may be encoded with additional instruction which, when executed by the at least one processor, further cause the computing system to receive, from a second client device operated by the owner of the first file, an input indicative of the at least one portion of the first file to be made accessible to the first user, and store the first data based on receipt of the input from the second client device.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a computing system and from a first client device operated by an owner of a first file, an input indicative of at least one portion of the first file is to be made accessible to a first user;
determining that the first file is to be shared with the first user;
generating, by the computing system based on the input from the first client device and the first file, a second file including the at least one portion of the first file and excluding other portions of the first file; and
based on determining that the first file is to be shared with the first user, sending, by the computing system to a second client device operated by the first user, the second file so as to limit access, by the first user, to content of the first file.

2. The method of claim 1, further comprising:
based on the input from the first client device, storing, by the computing system, first data associating the at least one portion of the first file with the first user.

3. The method of claim 2, further comprising:
based on determining that the first file is to be shared with the first user, retrieving the first data; and
generating the second file based on retrieving the first data.

4. The method of claim 1, wherein the first file is to be shared with a second user, and the method further comprises:
determining, by the computing system, second data indicative of at least another portion of the first file to be made accessible to the second user, the second data being indicated by the owner of the first file;
generating, by the computing system and based on the second data and the first file, a third file including the at least another portion and excluding other portions of the first file; and
based on determining that the first file is to be shared with the second user, sending, by the computing system to a third client device operated by the second user, the third file so as to limit access, by the second user, to content of the first file.

5. The method of claim 1, further comprising:
receiving, by the computing system and from the second client device, a request to access the first file;
wherein the second file is generated in response to receiving the request from the second client device.

6. The method of claim 1, further comprising:
receiving, by the computing system and from the first client device, a request to limit access to content of the first file; and
causing, by the computing system, the first client device to display the content of the first file to enable selection of the at least one portion of the first file and enable indication of at least the first user that is allowed to access the selected at least one portion of the first file.

7. The method of claim 1, further comprising:
receiving, by the computing system and from the first client device, the first file.

8. The method of claim 1, wherein the input received from the first client device further indicates at least another portion of the first file is to be made accessible to a second user.

9. The method of claim 1, further comprising:
receiving, by the computing system and from the first client device, an additional input indicative of at least another portion of the first file is to be made accessible to a group of users;
generating, by the computing system based on the additional input and the first file, a third file including the at least another portion of the first file and excluding other portions of the first file; and
sending, by the computing system to at least a third client device operated by a second user of the group of users, the third file so as to limit access, by the second user, to content of the first file.

10. A method, comprising:
receiving, by a computing system and from a first client device operated by a first user, a request for a copy of a first file;
determining, by the computing system, first data indicative of at least one portion of the first file is to be made accessible to the first user, the first data being indicated by an owner of the first file;
generating, by the computing system and based on the first data, a second file including the at least one portion of the first file and excluding other portions of the first file; and
in response to the request for the copy of the first file, sending, by the computing system to the first client device, the second file so as to limit access, by the first user, to content of the first file.

11. The method of claim 10, further comprising:
receiving, by the computing system and from a second client device, a request for the copy of the first file;
determining, by the computing system, second data indicative of at least another portion of the first file is to be made accessible to a second user, the second data being indicated by the owner of the first file;
generating, by the computing system and based on the second data, a third file including the at least another portion of the first file and excluding other portions of the first file; and
in response to the request for the copy of the first file, sending, by the computing system to the second client device, the third file so as to limit access, by the second user, to content of the first file.

12. The method of claim 10, further comprising:
receiving, by the computing system and from a second client device operated by the owner of the first file, an input indicative of the at least one portion of the first file to be made accessible to the first user; and
storing the first data based on receipt of the input from the second client device.

13. A computing system comprising:
at least one processor; and
at least one computer-readable medium encoded with instructions which, when executed by the at least one processor, cause the computing system to:
receive, from a first client device operated by an owner of a first file, an input indicative of at least one portion of the first file is to be made accessible to a first user;
determine that the first file is to be shared with the first user;
generate, based on the input from the first client device and the first file, a second file including the at least one portion of the first file and excluding other portions of the first file; and
based on determining that the first file is to be shared with the first user, send, to a second client device operated by the first user, the second file so as to limit access, by the first user, to content of the first file.

14. The computing system of claim 13, wherein the at least one computer-readable medium is encoded with additional instructions which, when executed by the at least one processor, further cause the computing system to:
based on the input from the first client device, store first data associating the at least one portion of the first file with the first user.

15. The computing system of claim 14, wherein the at least one computer-readable medium is encoded with additional instructions which, when executed by the at least one processor, further cause the computing system to:
based on determining that the first file is to be shared with the first user, retrieve the first data; and
generate the second file based on retrieving the first data.

16. The computing system of claim 13, wherein the first file is to be shared with a second user, and wherein the at least one computer-readable medium is encoded with additional instructions which, when executed by the at least one processor, further cause the computing system to:
determine second data indicative of at least another portion of the first file to be made accessible to the second user, the second data being indicated by the owner of the first file;
generate, based on the second data and the first file, a third file including the at least another portion and excluding other portions of the first file; and
based on determining that the first file is to be shared with the second user, send, to a third client device operated by the second user, the third file so as to limit access, by the second user, to content of the first file.

17. The computing system of claim 13, wherein the at least one computer-readable medium is encoded with additional instructions which, when executed by the at least one processor, further cause the computing system to:
receive, from the second client device, a request to access the first file;
wherein the second file is generated in response to receiving the request from the second client device.

18. The computing system of claim 13, wherein the at least one computer-readable medium is encoded with additional instructions which, when executed by the at least one processor, further cause the computing system to:
receive, from the first client device, a request to limit access to content of the first file; and
cause the first client device to display the content of the first file to enable selection of the at least one portion of the first file and enable indication of at least the first user that is allowed to access the selected at least one portion of the first file.

19. The computing system of claim 13, wherein the at least one computer-readable medium is encoded with additional instructions which, when executed by the at least one processor, further cause the computing system to:
receive, from the first client device, the first file.

20. The computing system of claim 13, wherein the input received from the first client device further indicates at least another portion of the first file is to be made accessible to a second user.
